(19) United States
(12) Patent Application Publication
(10) Pub. No.: US 2025/0242632 A1
(43) Pub. Date: Jul. 31, 2025

(54) VEHICLE WHEEL

(71) Applicant: KT PROJEKTENTWICKLUNGS-GMBH, Heilbronn (DE)

(72) Inventors: Konstantinos TSIBERIDIS, Untergruppenbach (DE); Eleni TSOUROUKIDOU, Pfullendorf (DE)

(21) Appl. No.: 18/836,983

(22) PCT Filed: Feb. 9, 2023
(86) PCT No.: PCT/EP2023/053151

§ 371 Date: Aug. 8, 2024

(30) Foreign Application Priority Data
Feb. 9, 2022 (DE) 10 2022 102 999.9

(51) Int. Cl. B60B 7/04

(52) U.S. Cl. CPC B60B 7/04; B60B 2900/1216

(57) ABSTRACT

The invention relates to a vehicle wheel rim, comprising a rim body (12) which has a hub section (14), a rim base (16), multiple support sections (20) that are arranged between the hub section (14) and the rim base (16), at least one gap (22) which is arranged between the support sections (20), and at least one cover element (28) which is associated with the gap, wherein the cover element can be transferred from a first position into a second position by means of an actuation device, and the coverage of the gap by means of the cover element in the first position differs from the coverage of the gap by means of the cover element in the second position. The cover element deforms upon transitioning from the first position to the second position. The actuation device is formed by an expansion element (40; 40′) which automatically starts to move the cover element (28) from the first position in the direction of the second position when a first defined temperature is exceeded.

The present invention relates to a vehicle wheel rim according to the preamble of patent claim 1. Such a rim is known from EP 3 694 727 B1.

Modern motor vehicles should have as low a drag as possible in order to reduce the energy consumption of a vehicle in particular at higher speeds. The rims of the vehicle wheels should also make their contribution to reducing the drag. In order to achieve a flow of air around a vehicle rim that is as low-drag as possible, the surface of the rim that is on the exterior of the vehicle should be as smooth and closed as possible, in order to avoid air turbulence, which increases the drag, as far as possible.

On the other hand, it is also a requirement to be able to cool the brakes of a vehicle, which are usually arranged in the space surrounded by the vehicle rims, in the best possible manner. For this purpose, as high a flow of air as possible through the surface of the rim is required, in order to be able to ensure a sufficient air flow to the vehicle brake both while a vehicle is moving and while it is stationary. This requirement is diametrically opposed to the requirement explained above for a rim surface that is as closed as possible.

In order to achieve these conflicting aims, European patent 3 694 727 mentioned at the beginning proposes a rim according to the preamble for a vehicle wheel, in which openings in the rim surface are closed by one or more cover elements, wherein such a cover element is able to deform by pneumatic, electrical or magnetic actuation between a first position and a second position in order, as required, to open gaps in the rim surface such that cooling air is able to flow through the gaps. However, this known solution on the one hand requires pneumatic, electrical or magnetic actuators for deforming the cover element or the cover elements from a first position into a second position, and on the other hand requires an associated sensor system (temperature sensor, traveling speed sensor, etc.) and a control logic, which cooperates with the sensor system, for deciding when a cover element is to deform from its first position into its second position. This obviously results in an increase in the complexity and the costs.

The object underlying the invention is to provide a solution to the conflicting aims which have been described, which on the one hand retains the advantages of the known solution and on the other hand is less complex and at the same time more cost-efficient.

Proceeding from the prior art mentioned at the beginning, this object is achieved according to the invention by a rim for a vehicle wheel which includes the features indicated in patent claim 1. A rim according to the invention for a vehicle wheel is accordingly distinguished in that an actuating device, by means of which a cover element can be transferred from a first position into a second position, is formed by a so-called expansion element which, when a first predefined temperature is exceeded, automatically begins to displace the cover element from the first position in the direction towards the second position.

Expansion elements are known per se. They have been used for many years in thermostats in order to maintain a desired temperature in cooling and/or heating liquid circuits. An expansion element usually consists of a housing and a piston-or ram-like component, which is surrounded by an expanding material located in the housing. The housing of an expansion element is usually sealed using a membrane or an elastomer insert, which is connected in a force-transmitting manner to the piston or ram. Oil, wax and hard paraffin, for example, have become established as expanding materials. As a result of the temperature acting on the expansion element from outside, the expanding material changes volume in the sense of an increase in volume when a first predefined temperature is exceeded and as a result moves the piston- or ram-like component, whereby in a thermostat a valve is controlled. When the temperature falls below a second predefined temperature, which is higher than the first predefined temperature, the volume of the expanding material reduces again, as a result of which the piston- or ram-like component can be moved back in the direction towards its starting position, usually by a spring force. In dependence on the position of the piston or ram, a cooling and/or heating liquid stream can thus be controlled by means of an associated valve in order to keep the temperature in a heating and/or cooling system at a substantially constant level.

By suitably dimensioning the measurements of expansion elements and by suitably choosing and designing the expanding material that is used, expansion elements can be so produced in a large number of variants that, within a wide range, they provide a desired actuating force, a desired small or also large lift and a desired control range. The temperature range in which such expansion elements can be used for control purposes is, for example, from −20° C. to +130° C. but may also lie significantly outside this temperature range in the case of special requirements. The first predefined temperature and the second predefined temperature are given by suitably choosing and designing the expanding material and determine the desired control range in ° C., for example from 60 to 80° C., from 65 to 80° C., from 71 to 85° C., from 75 to 90° C., from 83 to 95° C., etc. Expansion elements of the described type are produced and marketed, for example, by ACS GmbH of 83703 Gmund/Germany.

The actuating device, formed by an expansion element, of the rim according to the invention reliably ensures that a cover element (or also a plurality of cover elements) associated with the actuating device is displaced from the first position in the direction towards the second position when the first predefined temperature is exceeded, without a pneumatic, electrical or magnetic actuator controlled by a sensor system for detecting a temperature and/or further parameters being necessary for this purpose.

Preferably, the or each cover element is so designed that it has a planar extent predominantly in the radial direction and also in the circumferential direction. As a result, on the one hand it is ensured that such a cover element can easily be deformed, and on the other hand it is ensured that a gap associated with the cover element can reliably be opened and closed.

In preferred embodiments of the rim according to the invention, the or each cover element has a fastening portion, which is non-displaceably connected to the rim body of the rim, wherein this fastening portion is preferably located radially on the outside with respect to the rim body and/or extends in a circumferential direction. In this manner, each cover element is securely fixed to the rim body. A fastening portion arranged radially on the outside with respect to the rim body advantageously allows an actuating device associated with the cover element to be arranged in a radially inner region of the rim. An additional mass in the radially inner region of the rim results in lower circumferential forces on rotation of the rim.

In preferred embodiments of the rim according to the invention, the cover element has an actuating portion which is arranged so as to be movable, in particular so as to be displaceable, relative to the rim body of the rim, wherein this actuating portion is preferably located on the inside with respect to the rim and/or extends in a circumferential direction, and wherein the actuating portion is preferably movable or displaceable in an axial direction and/or in a radial direction and/or in a circumferential direction. An arrangement of the actuating portion radially on the inside with respect to the rim advantageously allows this actuating portion to be coupled with an actuating device, likewise arranged radially on the inside, of the associated cover element. The actuating portion of the cover element is preferably present in addition to the above-mentioned fastening portion, so that a cover element comprises, for example, a fastening portion arranged radially on the outside and an actuating portion arranged radially further on the inside. Preferably, the actuating portion of a cover element is arranged so as to be displaceable or pivotable with respect to the rim body, and such a displacement or pivoting can preferably be forcibly guided, that is to say can run along a given movement path.

Preferably, the first position of the cover element is a position in which the gap associated with the cover element is covered by the cover element to a greater extent than in the second position. The second position is thus a position that is further open compared to the first position. The first position can be the position in which the gap associated with the cover element is covered completely by the cover element. Such a position can also be referred to as the closed position of the cover element. The second position can be a position in which the cover element assumes a maximum open position in respect of the gap associated therewith. Such a position can also be referred to as a completely open position of the cover element. Intermediate positions are likewise possible.

Preferably, a or each cover element bulges axially outwards or axially inwards relative to the rim surface at least in some regions as it is transferred from the first position into the second position. In the case of a planar extent of a cover element as explained above, such a bulging of the cover element axially outwards or axially inwards at least in some regions can be used to form in a simple manner between the cover element and the rim body, on two opposite sides of the cover element (for example on two opposite sides in the circumferential direction), openings through which air can flow into the gap, associated with the cover element, of the rim. Alternatively and/or in addition, bulging of the cover element at least in some regions can, however, also take place on only one side of the cover element, for example in order to convey a directed inflow of cooling air into the gap in the case of a moving vehicle, for example in that the opening produced between the cover element and the rim body by the bulging of the cover element faces a direction of travel of the vehicle at least temporarily.

Rims according to the invention preferably have a plurality of gaps formed in their rim body, wherein a cover element is associated with each of a plurality of these gaps. Preferably, a cover element is associated with each gap.

When a rim according to the invention has a plurality of cover elements, then in some embodiments of the rim according to the invention a separate expansion element is associated with each cover element as the actuating device. In order to actuate each cover element, a piston or ram of the expansion element is preferably connected in a force-transmitting manner to an actuating portion of the associated cover element.

In alternative embodiments of a rim according to the invention, a plurality or all of the cover elements cooperate with a single expansion element as the actuating device. Preferably, such a single expansion element is arranged in the hub portion of the rim body. In the hub portion of the rim body, the mass associated with a single actuating device results in almost no circumferential forces on rotation of the rim, which is advantageous for smoother running of the rim.

When only a single expansion element is arranged in the rim portion of the rim body, then the actuating portions of the cover elements cooperating with this expansion element are preferably provided with a projection, which is connected in an articulated manner to the respective actuating portion and extends into the hub portion of the rim body. Via such projections, the actuating device in the form of a single expansion element is able to actuate the plurality of cover elements or each cover element. According to a preferred embodiment, all these projections are connected in an articulated manner to an actuating plate, which is displaceably arranged in the hub portion of the rim body. The piston or ram of the single expansion element is then able to act substantially in an axial direction on this actuating plate, which extends at least substantially at right angles to an axial direction in which the piston or ram of the expansion element moves, in order to transfer the cover elements from the first position into the second position. This axial direction can also be an axial direction with respect to the rim, in particular the center axis of the rim.

Regardless of whether a rim according to the invention has one actuating device or a plurality of actuating devices, the cover element, a plurality of cover elements or each cover element are preferably formed of an elastically reversibly deformable material or comprise at least one such material. In this manner, on transfer from the first position into the second position, a spring force can build up in the deformed cover element and, when the temperature falls below the second predefined temperature already mentioned, ensures that the cover element, a plurality of cover elements or each cover element automatically moves back from the second position in the direction towards the first position. Such an embodiment of the cover element, a plurality of cover elements or each cover element allows a separate return spring or return springs to be omitted and thus results in yet a further structural simplification of a rim according to the invention. If desired, or if necessary in the case of a cover element material that does not build up a springy return force, one or more return spring elements can also be used.

Preferred embodiments of rims according to the invention are distinguished in that, when the cover element or the cover elements assume a position in which a gap associated with the respective cover element is completely covered, the cover element or elements extend at least substantially flush with the carrier portions which delimit the respective gap with which the respective cover element is associated. In other words, the respective cover element then extends substantially flush with the surface of the rim body that is on the exterior side of the vehicle.

The invention relates also to a vehicle wheel which is equipped with a rim according to the invention, and further to a vehicle which has a vehicle wheel or a plurality of vehicle wheels which are equipped with a rim according to the invention.

Exemplary embodiments of the rim according to the invention will be explained in greater detail hereinbelow with reference to the accompanying schematic drawings, in which:

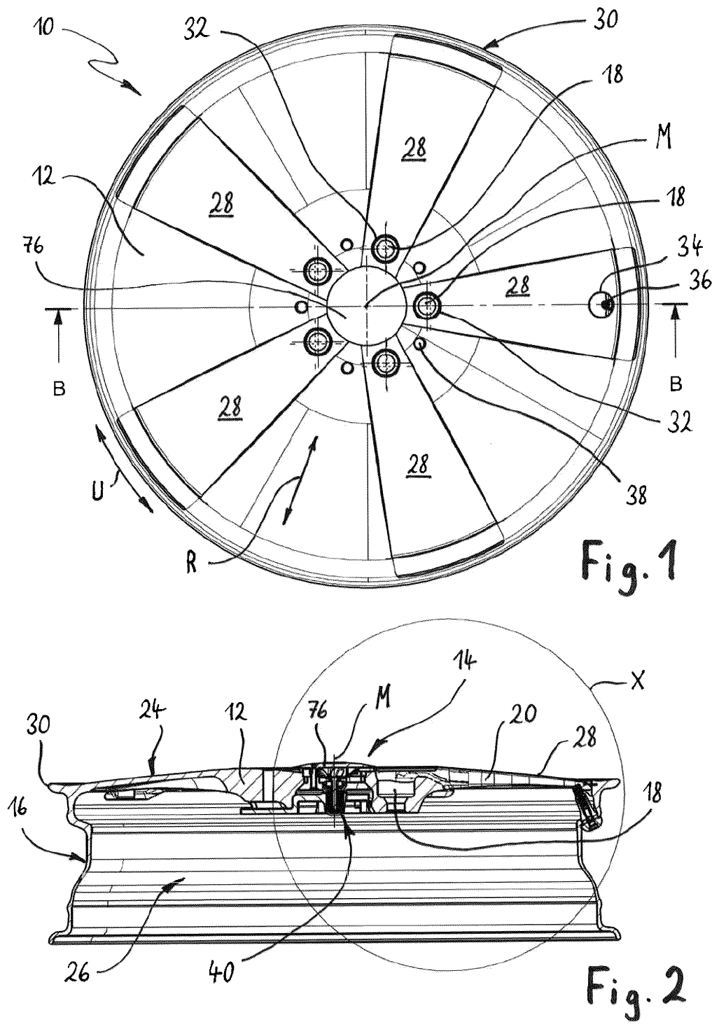

FIG. 1 is a top view of a first exemplary embodiment of a vehicle wheel rim according to the invention,

FIG. 2 is a cross section through the first exemplary embodiment shown in FIG. 1, along line B-B in FIG. 1,

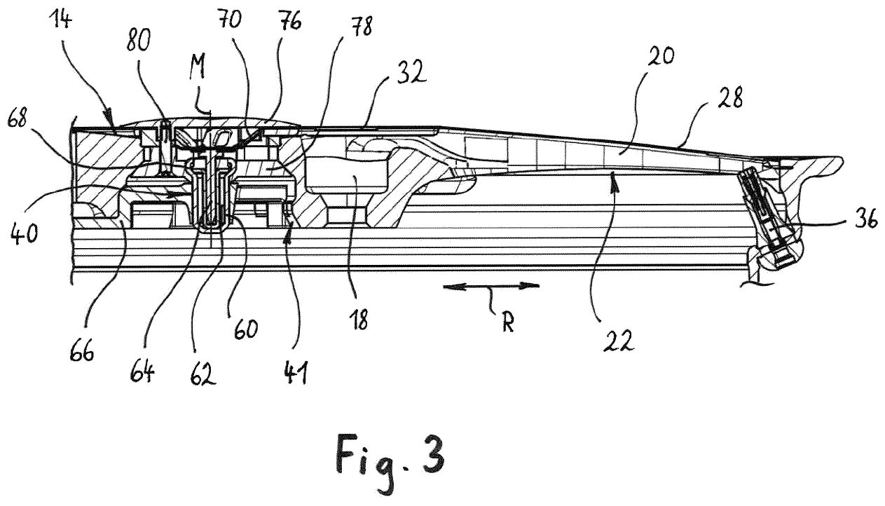

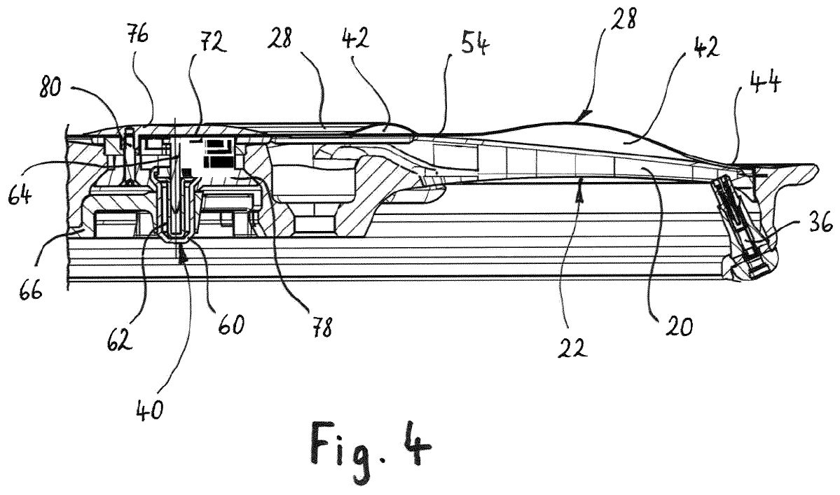

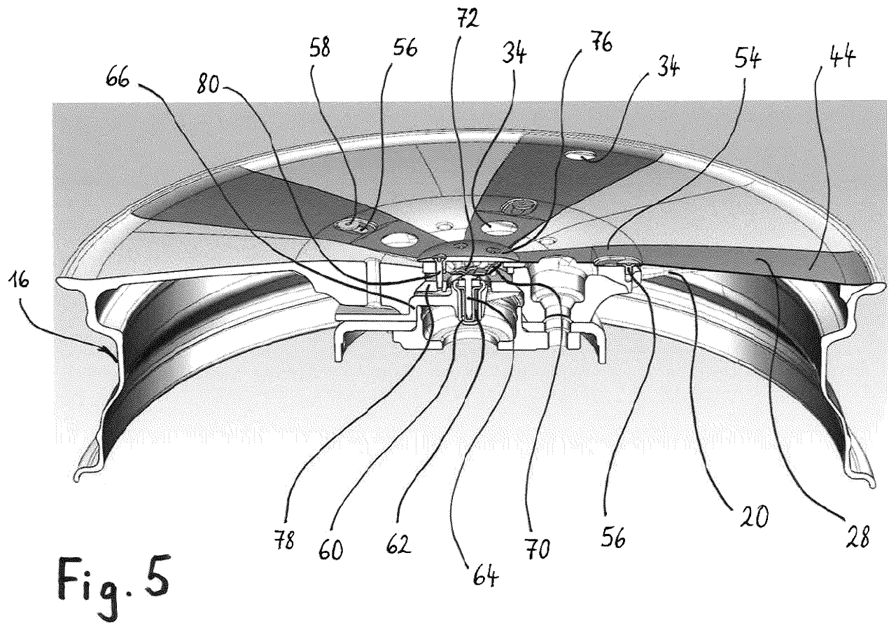

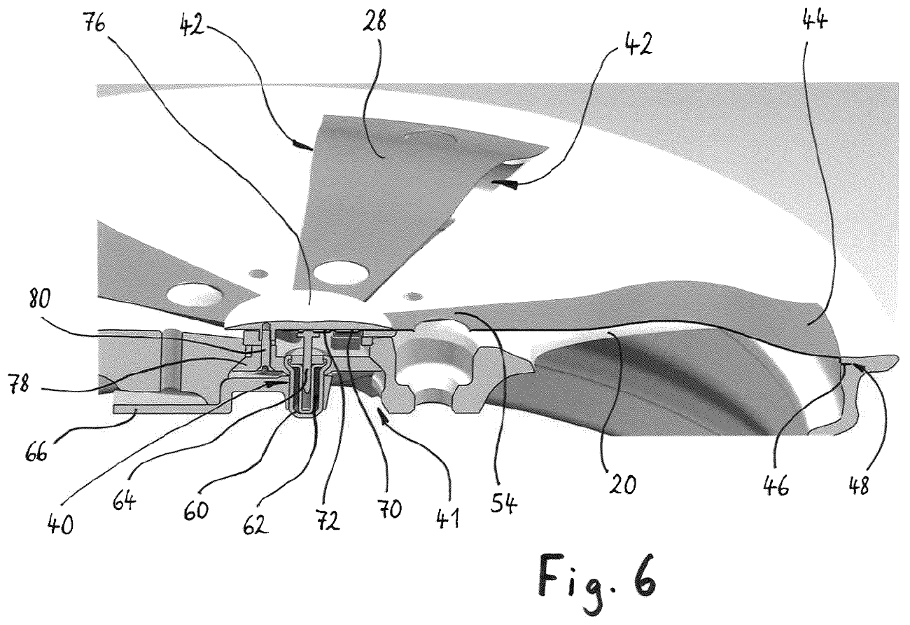

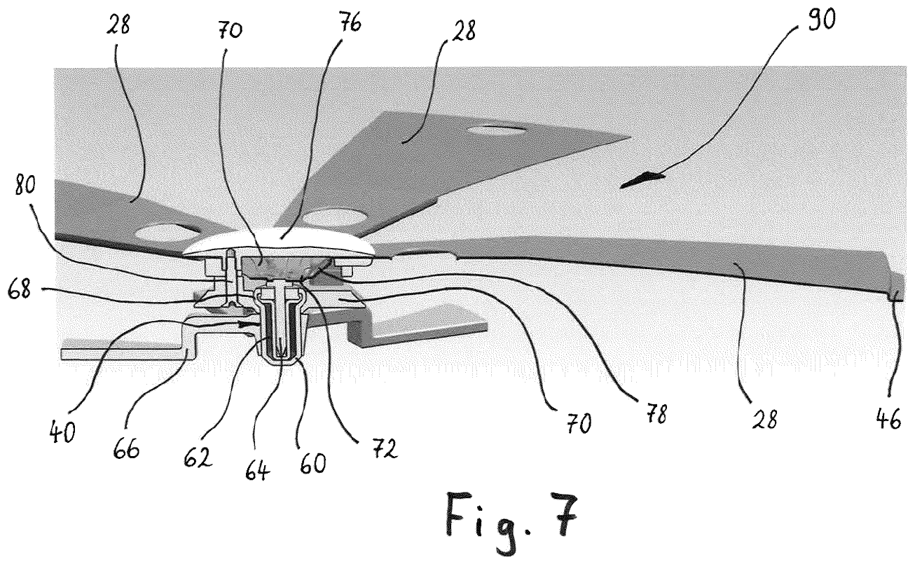

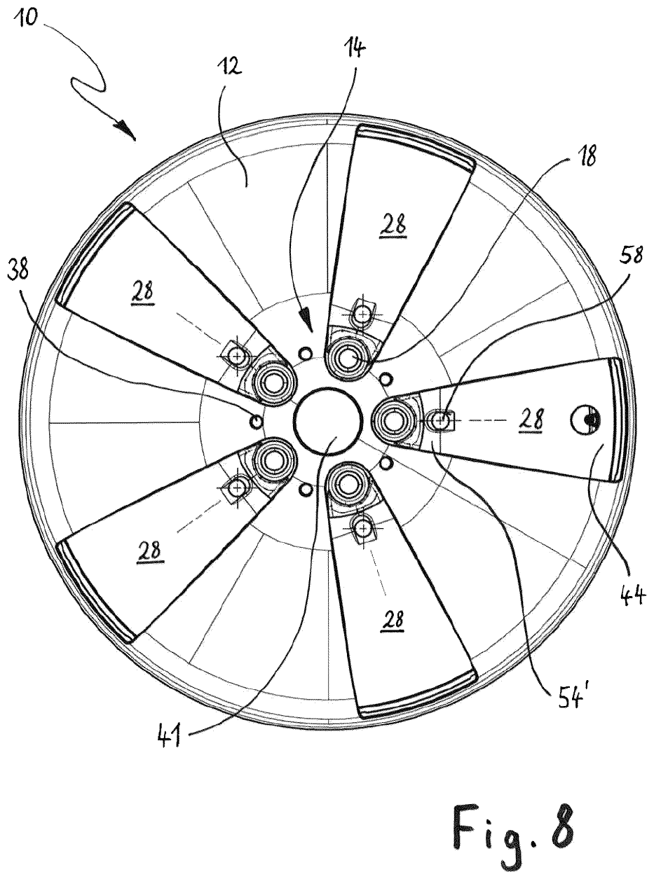

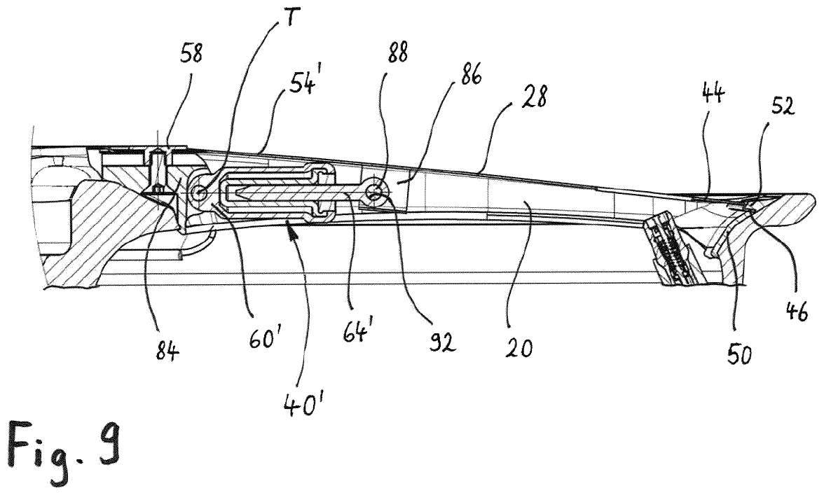

FIG. 3 shows detail X from FIG. 2 in an enlarged representation,

FIG. 4 shows the view of FIG. 3 but with the cover element open,

FIG. 5 shows a perspective sectional representation of the first exemplary embodiment shown in FIG. 1, in a slightly modified form,

FIG. 6 shows a perspective sectional representation of part of the first exemplary embodiment in a state in which cover elements are open,

FIG. 7 shows a perspective partial sectional representation of a cover element assembly according to the first exemplary embodiment,

FIG. 8 shows a second exemplary embodiment of a vehicle wheel rim according to the invention, in a top view,

FIG. 9 shows a view corresponding to FIG. 3 of the second exemplary embodiment,

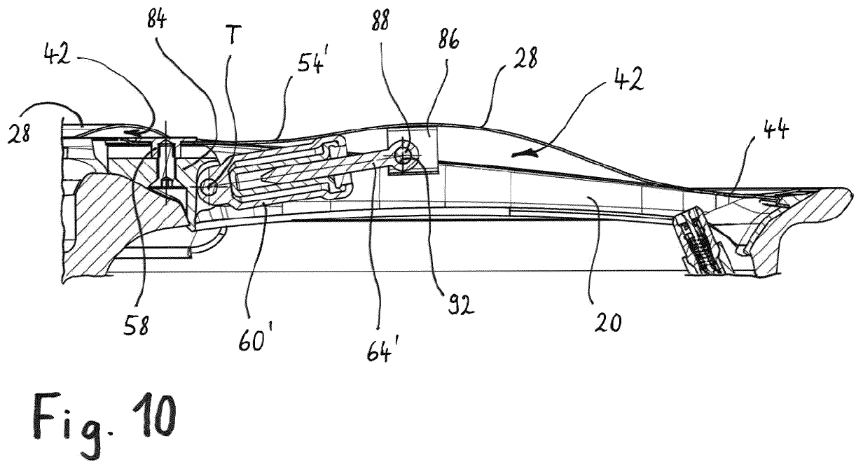

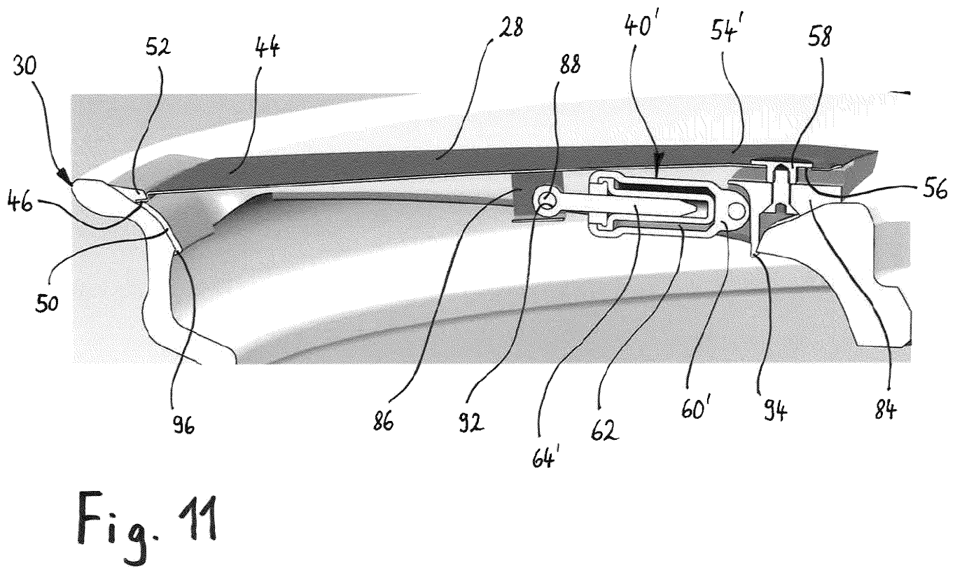

FIG. 10 shows a view corresponding to FIG. 4 of the second exemplary embodiment,

FIG. 11 shows a perspective partial sectional representation of a detail of the second exemplary embodiment in a non-actuated state in which a cover element is closed, and

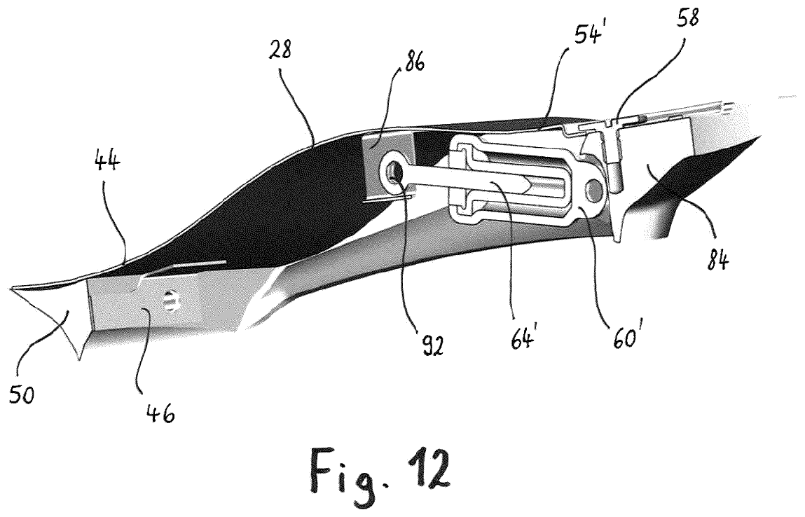

FIG. 12 is a view similar to the view of FIG. 11 in an actuated state in which the cover element is open.

A first exemplary embodiment of a vehicle wheel rim 10 according to the invention will now be described in greater detail with reference to FIGS. 1 to 7. The rim 10 can be, for example, a so-called alloy rim for a passenger car, which rim has been produced from a light-metal alloy, for example by means of a casting process, in a manner which is generally known and therefore not explained in greater detail.

The rim 10 comprises a rim body 12, which may have been produced, for example, by casting from the light-metal alloy already mentioned, having a hub portion 14 arranged in the center of the rim 10 and a rim well 16 arranged radially on the outside in a circumferential annular manner, for holding a tire (not shown here). The hub portion 14 arranged concentrically with a center axis M serves inter alia for fastening the rim 10 to a vehicle (not shown) and has for this purpose a plurality of bolt holes 18 (in the present case five bolt holes), which extend parallel to the center axis M and each serve to receive a bolt (not shown here) with which the rim 10 can be bolted to an axle or wheel suspension of a vehicle.

Between the hub portion 14 arranged radially on the inside and the rim well 16 located radially on the outside there extend a plurality of carrier portions 20 (here five carrier portions), which are frequently also referred to as arms or spokes. In the present case, the hub portion 14, the carrier portions 20 and the rim well 16 are formed integrally with one another by casting of the rim body 12, although that does not have to be the case. Instead, depending on the material used for the rim body 12 and depending on the production method for the rim body 12, embodiments are also possible in which the rim body 12 consists of a plurality of parts which are produced separately from one another and then joined together.

Each two carrier portions 20 that are adjacent to one another in a circumferential direction U of the rim 10 delimit between them a gap 22, which forms a through-opening between an upper side 24 of the rim and an interior space 26 of the rim 10 enclosed by the rim well 16. When the rim 10 is mounted on an axle or wheel suspension (not shown) of a vehicle, then there is usually located in the rim interior space 26 a vehicle brake (not shown), frequently a so-called disk brake, with which the vehicle can be slowed down and which is fixedly connected to the axle or wheel suspension of the vehicle. Owing to the frictional heat which is generated during a braking operation by the friction between a rotating component (e.g. drum or disk) of the brake and fixed friction linings (brake pads) of the brake, such a vehicle brake can become very hot during operation and must therefore be cooled in order that it can reliably perform its braking function. The gaps 22 in the rim body 12 allow an exchange of air between the interior space 26 of the rim 10 and the surrounding atmosphere, as a result of which cool air is able to flow to the brake and hot air is able to flow away from the brake. During driving operation, however, the gaps 22 cause air turbulence, which has a drag-increasing effect and therefore results in higher fuel consumption of the vehicle.

In order to eliminate the drag-increasing influence of the gaps 22 at least temporarily and nevertheless allow sufficient cooling of a vehicle brake, cover elements 28 associated with the gaps 22 are provided. In the embodiment shown, a cover element 28 is associated with each gap 22. Each cover element 28, when seen in a top view, has an approximately wedge-shaped form and serves to cover the associated gap 22 from outside. Each cover element 28 is a planar element, which extends mainly radially and in the circumferential direction U and the thickness of which is far smaller than its extent in the radial direction and in the circumferential direction. In the exemplary embodiment shown, each cover element 28 extends from the hub portion 14 almost to the outer circumferential edge 30 of the rim body 12. In the region of the hub portion 14, each cover element 28 is provided with an opening 32, which here is circular, which permits access to a bolt hole 18 arranged beneath, or to a bolt located in the bolt hole 18. One of the cover elements 28 is further provided close to its radially outer end with a further through-opening 34, which here is likewise circular, which permits access to a tire valve 36 located beneath, via which air can be supplied to or removed from the vehicle wheel when the tire is in the mounted state. Close to the radially inner end of each carrier portion 20, and in the circumferential direction between each two bolt holes 18, so-called polycontrol bores 38 are also formed in the rim body 12, which are used by some motor vehicle manufacturers when adjusting the wheel alignment of a vehicle wheel. These polycontrol bores 38 have no function within the context of the present invention, however.

As can better be seen in FIGS. 3 and 4, each cover element 38 is able to assume a first position, which can be, for example, the closed position shown in FIG. 3, and can be transferred from a first position into a second position, which can be, for example, the open position shown in FIG. 4. A cover element 28 is transferred from a first position into a second position by deformation of the cover element 28 by means of an actuating device, which is formed by a so-called expansion element 40 which, when a first predefined temperature is exceeded, automatically begins to displace the cover element 28 from the first position in the direction towards the second position. In the first exemplary embodiment according to FIGS. 1 to 7, the expansion element 40 is accommodated in a central recess 41 of the hub portion 14, which recess extends axially and here concentrically with the center axis M through the hub portion 14 of the rim body 12.

In the exemplary embodiment shown, each cover element 28 is deformed by displacement of its radially inner end region in the radial direction (radially outwards), so that a middle part, with respect to the radial extent, of the cover element 28 bulges upwards substantially in the axial direction, that is to say away from the upper side 24 of the rim. Accordingly, as soon as a cover element 28 has been displaced from its closed position shown in FIG. 3 into a second position, openings 42 between the respective carrier portion 20 and the cover element 28 are formed by the bulging of the cover element 28 on both sides thereof, and air is able to flow through the openings into and out of the gap 22 located beneath the cover element 28. The second position of the cover element 28 can be the position shown in FIG. 4, in which the cover element 28 assumes its maximum open position, but it can also be any position between the positions shown in FIG. 3 and FIG. 4 (in such an intermediate position the openings 42 are then correspondingly smaller).

In order that each cover element 28 is able to deform as explained above, it consists in the exemplary embodiments shown of an elastically reversibly deformable material (e.g. of a suitable plastics material or of a suitable metal or a suitable metal alloy) and is fixed with respect to the rim body 12 in the region of its radially outer end. In the exemplary embodiments shown, this fixing is effected by means of a fastening portion 44, which forms the radially outer part of the cover element 28 and is supported against the rim body 12 in the radial direction by means of a lug 46, for example. For this purpose, a channel 48 (see FIG. 6) can be provided in the region of the circumferential edge 30 of the rim body 12, into which channel the lug 46 connected to the fastening portion 44 engages. Alternatively, there can be provided a holding means 50, which is supported against the circumferential edge 30 and against which the lug 46 is supported in the radial direction, for example by positive engagement between the lug 46 and a radially inwardly directed projection 52 formed on the holding means 50 (see FIGS. 9 to 11) or by fixing the lug 46 to the holding means 50 by means of, for example, a screw or a rivet or by adhesive bonding, etc. (see FIG. 12, wherein a fastening element in the form of a screw or rivet is not shown).

Each cover element 28 is further mounted in the region of its radially inner end portion in such a manner that on the one hand it is held against the rim body 12 and on the other hand it is radially displaceable. For this purpose, in the exemplary embodiments shown, each cover element 28 has an actuating portion 54 arranged radially on the inside, which actuating portion is provided with an elongate hole 56 (see FIG. 5) through which there extends a screw 58 which fastens the actuating portion 54 to the rim body 12. The screw 58 has a screw head, the diameter of which is greater than a width of the elongate hole 56, so that, by the cooperation of the elongate hole 56 with the screw 58, radial guiding of the actuating portion 54 is achieved. The actuating portion 54 of each cover element 28 can thus be displaced radially within the region given by the length of the elongate hole 56 (i.e. its extent in the radial direction).

The expansion element 40 already mentioned serves to effect such a displacement. Such an expansion element 40 has a housing 60 for holding an expanding material 62, the volume of which changes in dependence on the ambient temperature. When a predefined (by the choice and form of the expanding material 62) first temperature is exceeded, the volume of the expanding material 62 increases. When the temperature falls below a predefined second temperature, which is higher than the predefined first temperature, the volume of the expanding material 62 decreases again. A piston or ram 64, which is guided in a sealed manner relative to the interior of the housing 60, projects with one end into the housing 60 and is pushed out of the housing 60 when the volume of the expanding material 62 increases. This temperature-dependent, automatic movement of the ram 64 is used to actuate the cover elements 28. The structure of the expansion element 40 is here indicated merely by way of example and also does not require further explanation, since expansion elements have already been known and commercially available for a long time in the field of liquid thermostats.

In the first exemplary embodiment shown in FIGS. 1 to 7, the expansion element 40 is arranged in the recess 41 in the center of the hub portion 40 of the rim body 12, and the movement of its ram 64 is used to actuate all the cover elements 28 simultaneously. In this exemplary embodiment, the housing 60 of the expansion element 40 is housed in a bracket 66, which is fastened to the rim body 12 from the interior space 26 of the rim and serves as a holder for the expansion element 40. In the exemplary embodiment shown, the housing 60 is so formed by a portion 68 (see FIG. 3) having an enlarged outside diameter that it is able to be supported in the axial direction against the bracket 66 when the ram 64 is pushed out of the housing 60.

In order that the lifting movement of the ram 64 can be transmitted to the cover elements 28, each actuating portion 64 is connected in an articulated manner to a projection 70, which extends, bending downwards (i.e. in the direction towards the expansion element 40), from the actuating portion 64 into the recess 41. In the exemplary embodiment shown, all the projections 70 are additionally connected in an articulated manner at their other end to an actuating plate 72, which is arranged in the recess 41 so as to be axially displaceable and here extends at right angles to the center axis M. For actuating the cover elements 28, a free end 74 of the ram 64 comes into contact with the underside, facing the ram, of the actuating plate 72 and pushes the actuating plate axially outwards, that is to say in the direction towards the upper side 24 of the rim. The projections 70 connected in an articulated manner on the one hand to the actuating plate 72 and on the other hand to the associated actuating portion 54 are thus pressed radially outwards and thus likewise displace the actuating portion 54 radially outwards, resulting in the bulging of each cover element 28 as already described.

A cover 76, which covers the central region of the hub portion 14 on the upper side 24 of the rim and in particular the recess 41, serves as an axial counter bearing for the projections 70 and the radially inner ends of the actuating portions 54 during such an actuation. Beneath the cover 76, in the hub portion 14 between the bracket 66 and the cover 76, there is a counter ring 78 through which one or more screws 80 extend and are able to engage into associated threaded bores formed on the inner side of the cover 76. By tightening the screws 80, a unit comprising the cover 76 and the counter ring 78 is formed, said unit being clamped by the tightening of the screws 80 with a circumferential flange 82, projecting radially between the cover 76 and the counter ring 78 into the recess 41, and thus being fastened to the rim body 12.

FIGS. 1 to 3, 5 and 7 show the unactuated state of the cover elements 28, in which each cover element 28 lies substantially flat on the upper side 24 of the rim and thus closes or covers the gap 22 located beneath the cover element 28. Owing to the small thickness of each cover element 28, the cover elements 28 in this state extend substantially flush with the carrier portions 20 and the upper side 24 of the rim, so that drag-increasing turbulence as air flows around the upper side 24 of the rim is largely avoided. In this state, the projections 70 extend out of the plane of the actuating portions 54 at a downward angle into the recess 41 in the hub portion 14, that is to say they extend downwards in the direction towards the expansion element 40. The actuating plate 72 in this state assumes a position which is axially closer to the expansion element 40, that is to say the actuating plate 72 is in this state located deeper in the central recess 41.

FIGS. 4 and 6 show a state in which the cover elements 28 are actuated to the maximum, that is to say in which the cover elements 28 are in their maximum open position. As can be seen from FIGS. 4 and 6, the lift of the ram 64 is so great in this state that the actuating plate 72 lies against the inner side, facing the actuating plate, of the cover 76, as a result of which the projections 70 and the actuating portions 54 connected thereto have been displaced radially outwards as far as is possible in this embodiment. The bulging of each cover element 28 axially outwards is thus maximum (based on the embodiment shown) and the openings 42 are as large as is possible in this embodiment.

Because each cover element 28, or at least the region of each cover element 28 that bulges, consists in the exemplary embodiments shown of an elastically reversibly deformable material, a spring force builds up in each cover element 28 during the transfer of the cover elements 28 from a closed or more closed position into a more open position, which spring force acts in a return direction, that is to say in a direction that closes the associated cover element 28. If, starting from the state shown in FIGS. 4 and 6, the ambient temperature of the expansion element 40 falls below the second predefined temperature, the volume of the expanding material 62 decreases and the lifting force acting on the ram 64 falls or even disappears altogether (after the temperature has fallen below the first predefined temperature). The spring force built up in each cover element 28, which acts back on the actuating plate 72 via the actuating portions 54 and the projections 70, then has the result that the actuating plate 72 is displaced axially inwards again, that is to say downwards, in the recess 41 and presses the ram 64 into the housing 60. This return motion takes place until an equilibrium is established between the return spring force and the lifting force provided by the expansion element 40. If the expansion element 40 no longer provides a lifting force, which is the case once the temperature has fallen below the first predefined temperature, the cover elements 28 are moved by the return spring force which has built up therein back into the closed position shown in FIGS. 1 to 3, 5 and 7.

In embodiments of a rim 10 according to the invention in which a return spring force builds up in the cover elements 28 when they are opened, the cover elements 28 are accordingly not only opened automatically (in dependence on the first predefined temperature by the expansion element 40), but are also returned or closed automatically (by the return spring force and in dependence on the second predefined temperature). In embodiments in which cover elements 28 are used that do not build up a spring force when they are deformed, one or more separate return spring elements can additionally be used in order to effect a return of open cover elements 28 in the direction towards the closed position (not shown).

FIG. 7 shows a cover element assembly 90, isolated from a rim body 12, which consists of the cover elements 28 with their actuating portions 54 and the associated projections 70 and also the actuating plate 72 connected thereto, the expansion element 40 with its ram 64, the bracket 66, the cover 76 and the counter ring 78 including the screws 80. This cover element assembly 90 corresponds in its construction to the arrangement shown in FIGS. 1 to 6. The cover elements 28 can be implemented, together with the projections 70 and the actuating plate 72, by an integral component manufactured, for example, by a plastics injection molding process. The articulated connections between the actuating plate 72 and the projections 70 on the one hand and between the projections 70 and the actuating portions 54 on the other hand can be formed in such a case by so-called foil hinges. Such a one-piece form can also be produced from sheet metal. Alternatively, the cover elements 28 in particular can be in the form of separate components (optionally together with the associated projection 70) and the actuating plate 72 can be a separate component (if desired together with the required projections 70) or the cover elements 28, the projections 70 and the actuating plate 72 can each be in the form of separate components. It is important merely that the axial lifting movement of the ram 64 of the expansion element 40 is converted into a radial displacement of the actuating portions 54 of the cover elements 28. A cover element assembly 90 as described above can also be retrofitted on a rim body 12 provided therefor.

FIGS. 8 to 12 show a second exemplary embodiment of a rim 10 according to the invention for a vehicle wheel, the second exemplary embodiment differing from the first exemplary embodiment especially in that there is no expansion element 40 arranged centrally in the recess 41 which is able to actuate all the cover elements 28 together in the manner described above. Instead, in the second exemplary embodiment, each cover element 28 is actuated by its own associated expansion element 40′. Accordingly, the bracket 66, the actuating plate 72 and the projections 70, the cover 76 and the counter ring 78 together with the screws 80 are absent from this second exemplary embodiment. Instead, an expansion element 40′ is arranged beneath the actuating portion 54′ of each cover element 28, the housing 60′ of which expansion element is pivotably connected at its end remote from the ram 64′ to an inner holding ring 84, which serves as a radially inner mounting for the cover elements 28. The inner holding ring 84 can consist of a single piece or can be composed of a plurality of portions and can consist of plastics material, metal or another suitable material. For example, each cover element 28 can have its own associated portion of the inner holding ring 84, so that each cover element 28 as a separate assembly can be inserted into or removed from the rim body 12. The radially outer holding means 50 can here be of integral form or can be composed in the circumferential direction U of a plurality of elements, depending on the manner in which the lug 46 of the cover element 28 is fastened to the holding means 50.

For simple connection to the rim body 12, the inner holding ring 84 and/or the annular holding means 50 can be clipped into the recesses of the rim body 12 that are formed by the gaps 22. For this purpose, as shown in FIG. 11, latching projections 94 or 96 can be provided axially inwardly on the inner holding ring 84 and/or on the annular holding means 50, which latching projections latch behind an edge of the recesses in the rim body 12 that are formed by the gaps 22.

In the second exemplary embodiment, the expansion element 40′ extends, as is shown in FIGS. 9 to 12, in the radial direction and is pivotable by the described mounting of its housing 60′ on the inner holding ring 84 about an axis T arranged tangentially to the circumferential direction U. For the force-transmitting connection of the expansion element 40′ to the cover element 28, the free end of the ram 64′ is pivotably connected in the manner of a connecting rod to an actuating lug 86 which is fixedly attached to the inner side of the cover element 28 and extends axially inwards. A pin 88 extending at right angles to the actuating lug 86 is fastened to the actuating lug 86 and engages into an eye 92 at the free end of the ram 64′ in order to connect the ram 64′ in an articulated manner to the cover element 28.

The functioning of the expansion element 40′ is in principle as described above in connection with the first exemplary embodiment. An increase in the volume of the expanding material 62, triggered by the first predefined temperature being exceeded, results in that the ram 64′ is pressed out of the housing 60′. Unlike in the first exemplary embodiment, however, the movement of the ram 64′ takes place not in the axial direction (as in the first exemplary embodiment), but in a substantially radial direction. The movement of the ram 64′ is transmitted via the pin 88 and the actuating lug 86 to the associated cover element 28, the actuating portion 54′ of which is mounted, analogously to the actuating portion 54 of the first exemplary embodiment, so as to be radially displaceable and accordingly is displaced radially, as a result of which the cover element 28 bulges. Such a bulging, actuated state of the cover element according to the second exemplary embodiment is shown in FIG. 12. As in the first exemplary embodiment, a spring force builds up, when the cover element 28 is of an appropriate form, as the cover element 28 is transferred from the closed position into an open position, which spring force, analogously to the first exemplary embodiment, ensures that the cover element 28 is returned as soon as the temperature falls below the second predefined temperature. Otherwise, the functioning of the cover elements 28 of the second exemplary embodiment and the advantages achieved thereby correspond to those of the first exemplary embodiment.

1-14. (canceled)

15. A vehicle wheel, comprising:
a hub portion,
a rim well for holding a tire,
a plurality of carrier portions extending radially between the hub portion and the rim well, at least some of the plurality of carrier portions defining a gap therebetween,
an actuating device, and
a plurality of cover elements each associated with a different one of the gaps, each of the plurality of cover elements configured to be deformed by the actuating device from a first position to a second position, wherein coverage of the respective gaps by the plurality of cover elements in the first position is different from coverage of the respective gaps by the plurality of cover elements in the second position,
wherein the actuating device comprises an expansion element configured to be responsive to a temperature of the expansion element exceeding a first predefined temperature to automatically deform each of the plurality of cover elements from the first position toward the second position.

16. The vehicle wheel of claim 15, wherein the expansion element has a housing and a piston or ram, the piston or ram surrounded by an expanding material contained in the housing, wherein a volume of the expanding material changes in dependence on the temperature.

17. The vehicle wheel of claim 15, wherein the hub, the rim well, and the plurality of cover elements together define a rim body,
and wherein each of the plurality of cover elements has a fastening portion non-displaceably connected to the rim body,
and wherein the fastening portion at least one of (i) is located radially on an outside of the rim body, and (ii) extends in a circumferential direction of the rim body.

18. The vehicle wheel of claim 15, wherein the hub, the rim well, and the plurality of cover elements together define a rim body,
and wherein each of the plurality of cover elements has an actuating portion at least one of (i) located radially on an inside of the rim body, and (ii) extends in a circumferential direction of the rim body,
and wherein the actuating portion of each of the plurality of cover elements is movable or displaceable in at least one of an axial direction, a radial direction, and a circumferential direction relative to the rim body.

19. The vehicle wheel of claim 15, wherein the gaps are covered by the plurality of cover elements to a greater extent in the first position of the plurality of cover elements than in the second position of the plurality of cover elements.

20. The vehicle wheel of claim 19, wherein the gaps are completely covered by the plurality of cover elements in the first position of the plurality of cover elements.

21. The vehicle wheel of claim 15, wherein the gaps are covered by the plurality of cover elements to a lesser extent in the second position of the plurality of cover elements than in the first position of the plurality of cover elements.

22. The vehicle wheel of claim 21, wherein the gaps are completely open in the second position of the plurality of cover elements.

23. The vehicle wheel of claim 15, wherein the hub, the rim well, and the plurality of cover elements together define a rim body,
and wherein each of the plurality of cover elements bulges axially outwards or axially inwards relative to the rim body upon deformation from the first position to the second position.

24. The vehicle wheel of claim 15, wherein the expansion element is arranged in the hub portion.

25. The vehicle wheel of claim 24, wherein each of the plurality of cover elements has an actuating portion and a respective projection connected thereto in an articulated manner, and each of the projections extends into the hub portion.

26. The vehicle wheel of claim 25, further comprising an actuating plate displaceably arranged in a recess of the hub portion, wherein the projections are connected in an articulated manner to the actuating plate,
wherein the expansion element has a piston or ram configured to act in an at least an axial direction on the actuating plate to deform the plurality of cover elements from the first position into the second position.

27. The vehicle wheel of claim 1, wherein each of the plurality of cover element comprises an elastically reversibly deformable material configured to build up a spring force in response to deformation of the cover element from the first position to the second position,
and wherein the elastically deformable material is responsive to the temperature of the expansion element falling below a second predefined temperature to move the plurality of cover elements with the spring force from the second position toward the first position.

28. The vehicle wheel of claim 20, wherein, with the gaps completely covered by the plurality of cover elements in the first position of the plurality of cover elements, each of the plurality of cover elements extends flush with a respective one of the plurality of carrier portions to delimit the respective gap with which the respective one of the plurality of cover elements is associated.

29. A vehicle, including at least one vehicle wheel as claimed in claim 1.
